(19) United States
(12) Patent Application Publication
(10) Pub. No.: US 2024/0003261 A1
(43) Pub. Date: Jan. 4, 2024

(54) METHOD FOR STOPPING A GAS TURBINE ENGINE OF A TURBOGENERATOR FOR AIRCRAFT

(71) Applicants: SAFRAN, Paris (FR); SAFRAN HELICOPTER ENGINES, Bordes (FR); SAFRAN POWER UNITS, Toulouse (FR)

(72) Inventors: Fabien Mercier-Calvairac, Moissy Cramayel (FR); Nicolas Claude Parmentier, Moissy-Cramayel (FR); Denis Antoine Julien Real, Moissy-Cramayel (FR)

(21) Appl. No.: 18/265,021

(22) PCT Filed: Dec. 1, 2021
(86) PCT No.: PCT/FR2021/052161

§ 371 Date: Jun. 2, 2023

(30) Foreign Application Priority Data
Dec. 4, 2020 (FR) FR2012664

(51) Int. Cl. F01D 15/10; F01D 21/00

(52) U.S. Cl. CPC F01D 15/10; F01D 21/00; F05D 2220/323; F05D 2220/76; F05D 2270/02

(57) ABSTRACT

This method for stopping at least one aircraft turbogenerator (1) comprises: —controlling the stopping (E1) of the turbogenerator (1); —passing from the nominal operating speed (N_{ref}) of the power shaft (3, 12) to a first operating speed (N₁) lower than the nominal speed (N_{ref}), for a first predetermined duration (t₂); —controlling the extinction of the combustion chamber (6) of the gas turbine (2); —maintaining the rotation of the gas turbine at a second speed (N₂) for a second predetermined duration (t₃), the power shaft (3, 12) being at a second speed (N₂) lower than the first operating speed (N₁) and, —controlling the stopping of the reversible electric machine (7) in order to no longer drive the power shaft (3, 12), in order to cause a progressive stopping (E9, E10) of the rotation of the gas turbine (2).

### TECHNICAL FIELD

The present invention relates to aircraft turbogenerators, and relates more particularly to cooling of the engine compartment of a gas turbine of such turbogenerators.

### PRIOR ART

In general, an aircraft comprises a propulsion set formed by a plurality of turbojet engines intended to provide the thrust necessary for propulsion thereof.

Nowadays, aeronautical manufacturers try to progressively reduce the environmental impact of aircrafts, primarily due to the combustion of kerosene, and that being so while maintaining sustained traffic.

To do so, it has been suggested to electrify the components involved in the propulsion functions of the aircraft, considered to be the primary source of energy consumption.

Electrification concerns both airliners and aircrafts operating in urban environments with vertical take-off and landing VTOL (standing for “Vertical Take-Off and Landing aircraft”) or short take-off and landing STOL (standing for “Short Take-Off and Landing aircraft”).

Nonetheless, it has been noticed that the complete electrification of the propulsion functions leads to excess weight related to the batteries and the wiring.

Therefore, it is advantageous to partially electrify the propulsion functions.

More particularly, the propulsion system comprises at least one electric machine driven by a gas turbine to supply electric power to the aircraft from fossil energy.

Propulsion is now provided by one or more turbogenerator(s) which could be supplemented by a set of rechargeable batteries allowing powering the electrical network of the aircraft and/or to power the electric machine and/or to store electrical energy at high energy density, for example between 250 and 350 Wh/Kg.

In general, such a turbogenerator comprises a gas turbine as well as a reversible electric machine.

By “reversible”, it should be understood a rotating machine able to transform the mechanical power produced by the gas turbine into electricity, but also transforming electrical energy into work by driving the gas turbine engine.

However, in the case of urban aircrafts that repeatedly perform short-duration missions, the turbogenerator is subject to a redundancy of start-up sequences followed by a use of the rated power and a stoppage, with no significant pause, between two journeys.

This leads to an overheating of the turbogenerator, to a significant thermal cycling of the mechanical assembly, to a premature ageing of the mechanical assembly, and possibly to the deterioration of the turbogenerator itself.

More specifically, during strong variations in power, the oil and/or fuel of the engine is likely to coke at its hot portion.

In general, these consist of the fuel injectors in the combustion chamber of the gas turbine.

Moreover, mechanical stresses such as a differential expansion are also accentuated.

To guard against this, the pilot is recommended to let the gas turbine rotate at a so-called “idle” speed for a predetermined duration before complete stoppage thereof.

This predetermined duration, generally defined according to the architecture of the gas turbine, does not guarantee a quick availability of the aircraft, in particular during emergency take-offs.

Consequently, it has been suggested to reduce this duration by implementing a so-called dry ventilation of the gas turbine, in other words, without injecting fuel into the combustion chamber.

On the ground, the gas turbine thus mixes the ambient air which is much colder than the gas turbine and that being so in order to cool it.

Another solution consists in adding a fan dedicated to the gas turbine, but this might significantly increase the size of the gas turbine and make it heavier.

### DISCLOSURE OF THE INVENTION

In light of the foregoing, the invention proposes overcoming the aforementioned constraints by providing a method for progressively stopping a gas turbine for an aircraft.

Hence, an object of the invention is a method for stopping at least one turbogenerator for an aircraft, comprising a reversible electric machine coupled to a gas turbine throughout at least one power shaft initially in a rated operating speed.

The method comprises:
controlling the stoppage of the turbogenerator;
switching from the rated operating speed of the power shaft to a first operating speed lower than the rated speed, for a first predetermined duration;
controlling the extinction of the combustion chamber of the gas turbine;
keeping the gas turbine rotating at a second operating speed by driving it by the reversible electric machine electrically powered and operating in the motor mode for a second predetermined duration, the power shaft being in the second speed lower than the first operating speed, and
controlling the stoppage of the reversible electric machine to no longer drive the power shaft and cause a progressive stoppage of the rotation of the gas turbine.

The first operating speed is herein close to the idle speed and allows, thanks to a minimum injection of fuel into the combustion chamber, starting cooling of the gas turbine and its compartment while delivering a minimum of power at the output of the engine.

At the end of this first predetermined duration, the electric machine is stopped by cutting off the fuel injection.

In other words, there is no more fuel combustion, which quickly reduces the temperature of the gas turbine.

In order to optimise cooling, the electric machine drives the gas turbine for the second predetermined time so that it mixes air.

Thus, when it is necessary to perform an emergency power call while the aircraft is beginning a descent phase characterised by a stoppage of the turbogenerator, the time required to restart the turbogenerator is reduced because the gas turbine is already cooled and therefore does not fear a blockage by heat accumulation.

The time needed to restart the turbogenerator is further reduced because the gas turbine is already driven in rotation at a certain speed by the electric machine.

It should be noted that when a turbogenerator comprises a multi-engine architecture, i.e. having at least two rotary shafts, the first and second predetermined durations as well as the speed levels, may be different from one shaft to another.

Advantageously, the electric machine is coupled to electric power supply means, the method comprising verifying, following the stoppage control, the electrical energy level of the power supply means, and if the electrical energy level is lower than a threshold value, an electrical generation control enabling the control of the gas turbine at a required mechanical power level and the control of the electric machine in the generator mode for the generation of an electric power for the first duration, able to be stored in the power supply means so as to reach the threshold value.

In order to keep the gas turbine rotating by the electric machine and without fuel injection, it is advantageous that the electric machine could be supplied with electrical energy by the power supply means for the second predetermined duration.

Thus, before stopping fuel injection, it is verified whether the electrical energy level of the power supply means is sufficient to power the electric machine for the second duration, as well as to restart the gas turbine.

For example, the electrical energy level of the power supply means is higher than a threshold value comprised between 0.15 and 1.5 kWh.

Preferably, the first duration is comprised between 30 and 120 seconds, and the first operating speed is comprised between 50 and 70% of the rated operating speed of the power shaft of the gas turbine.

For example, the first operating speed of the turbogenerator is substantially equal to 60% of its rated operating speed.

In a twin-engine architecture, the first speed of a first rotary shaft may be comprised between 50 and 70% of the rated speed and that of the second rotary shaft between 50 and 70% of the rated speed, for example.

Preferably, the second duration is comprised between 60 and 300 seconds, and the second operating speed is comprised between 5 and 15% of the rated operating speed of the gas turbine.

Another object of the invention a device for stopping at least one turbogenerator for an aircraft, the turbogenerator including a reversible electric machine coupled to a gas turbine throughout a power shaft initially in a rated operating speed.

The device comprises:
control means able to generate a stoppage setpoint signal of the turbogenerator;
actuation means able to switch, for a first predetermined duration, the rated operating speed of the power shaft to a first operating speed lower than the rated speed;
control means for extinguishing the combustion chamber of the gas turbine;
means for keeping the gas turbine rotating at a second operating speed by driving it by the reversible electric machine electrically powered and operating in the motor mode for a second predetermined duration, the power shaft being in the second operating speed lower than the first operating speed, and
control means configured to stop the drive of the power shaft by the reversible electric machine and enable a progressive stoppage of the rotation of the turbogenerator.

Advantageously, the electric machine is coupled to electric power supply means, the device comprising comparison means configured to verify, following the generation of the stoppage setpoint signal, the electrical energy level of the power supply means, and if the electrical energy level is lower than a threshold value, the electric machine is able to generate, for the first duration, an electrical energy able to be stored in the power supply means so as to reach the threshold value.

Preferably, the first duration is comprised between 30 and 120 seconds, during which the first operating speed is comprised between 5 and 70% of the rated operating speed of the power shaft of the gas turbine.

Preferably, the second duration is comprised between 60 and 300 seconds, and the second operating speed is comprised between 5 and 15% of the rated operating speed of the power shaft of the gas turbine.

Advantageously, the electric power supply means comprise at least one battery able to power the electric machine.

To verify the electrical energy level of at least one battery, the comparison means are configured to communicate with a management system BMS (standing for “Battery Management System”) which allows obtaining the information relating to the electrical energy level of the battery.

Another object of the invention is an aircraft comprising at least one turbogenerator including at least one gas turbine, a reversible electric machine and at least one stopping device as defined hereinabove.

In other words, the stopping device is configured to control a single-engine or multi-engine architecture.

### BRIEF DESCRIPTION OF THE DRAWINGS

Other aims, features and advantages of the invention will appear upon reading the following description, given solely as a non-limiting example, and made with reference to the appended drawings wherein:

FIG. 1 schematically shows a sectional view of a single-engine turbogenerator according to the prior art;

FIG. 2 schematically represents a sectional view of a multi-engine turbogenerator with a conventional compressor;

FIG. 3 schematically illustrates a sectional view of a multi-engine turbogenerator with two compressors according to the prior art;

FIG. 4 illustrates the modules of a device for stopping at least one gas turbine engine of the single-engine or multi-engine turbogenerator according to an embodiment of the invention;

FIG. 5 shows a flowchart of a method for stopping the gas turbine engine implemented by said device according to an implementation of the invention, and

FIG. 6 represents a graph of the evolution of the operating speed of the motor of the gas turbine over time.

### DETAILED DISCLOSURE OF AT LEAST ONE EMBODIMENT OF THE INVENTION

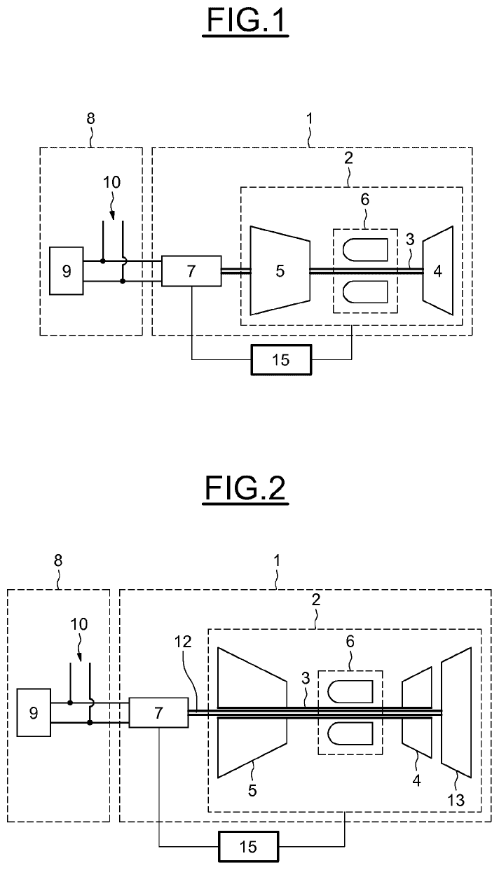

A turbogenerator 1 is represented in FIG. 1 intended to partially ensure the propulsion functions of an urban aircraft intended to perform short-duration missions repeatedly.

In this example, the turbogenerator 1 comprises a gas turbine 2 able to rotatably drive a unique motor shaft 3, itself coupled to a turbine 4 and to a compressor 5 of the gas turbine 2. Hence, the gas turbine 2 is herein a single-rotor turbomachine.

The compressor 5 comprising a set of fixed and movable fins, intended to compress the outside air.

The gas turbine 2 further comprises a combustion chamber 6 able to receive the air compressed by the compressor 5 and performing a combustion by mixing it with a fuel such as kerosene.

The turbogenerator 1 further comprises a reversible electric machine 7 able to operate in the generator mode and in the motor mode.

More specifically, when the electric machine 7 operates in the motor mode, the latter is configured to produce a torque able to drive the shaft 3.

To do so, the electric machine 7 is coupled to electric power supply means 8 which comprise one or more batteries 9.

As a non-limiting example and for the clarity, the power supply means 8 include a unique battery 9 intended to power the electric machine 7 so that the latter could operate in the motor mode.

Conversely, when the electric machine 7 operates in the generator mode, it transforms into electricity the mechanical power that it derives from the shaft 3.

In this case, the electric machine 7 is able to supply the battery 9 with electrical energy.

The power supply means 8 further comprise a HVDC (standing for “High-Voltage Direct Current”) high-voltage electric power grid 10, delivering for example a direct-current voltage higher than 270 volts, coupled to the battery 9 in order to supply with direct-current electrical energy.

Moreover, the high-voltage power supply network 10 is coupled to the electric machine 7 so that it could operate in the motor mode.

Alternatively, as illustrated in FIG. 2, the gas turbine 2 comprises two rotating shafts 3 and 12 as well as a second turbine 13, which may be herein called free turbine because it is not linked to a compressor 6 of the gas turbine 2.

In this configuration, the second turbine 13 is connected to the electric machine 7 by the shaft 12 concentric with the shaft 3 and independent in rotation of the latter.

Hence, the gas turbine 2 is herein a twin-rotor turbomachine, since it comprises two independent rotating shafts 3 and 12.

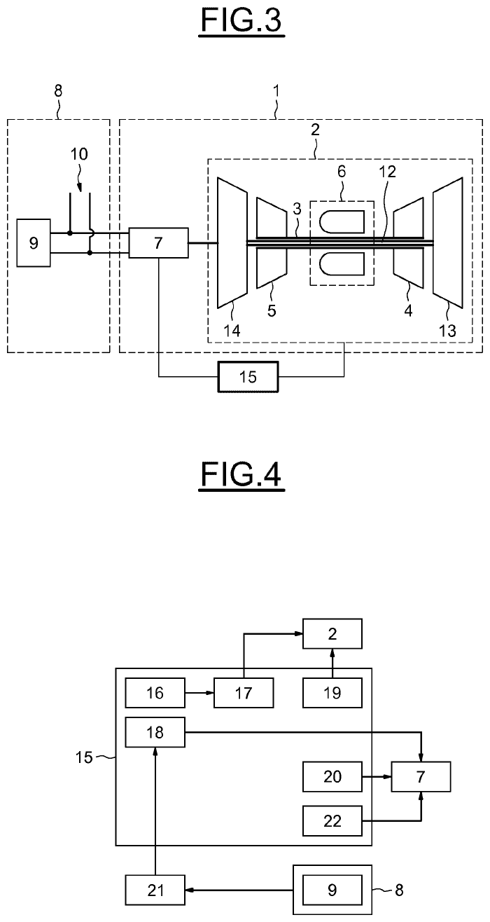

In another twin-rotor turbomachine variant, the gas turbine 2 further includes a second compressor 14 linked to the second turbine 13 by the shaft 12 concentric with the shaft 3 and independent in rotation of the latter, as illustrated in FIG. 3.

Whether the turbomachine is single-rotor or twin-rotor, it comprises the shaft 3 or the shaft 12 respectively, through which the mechanical power could be derived to drive the electric machine 7 operating in the generator mode. This shaft may be called the power shaft. In a twin-rotor turbomachine, the power shaft 12 is also called the low-pressure shaft, the shaft 3 then being called the high-pressure shaft.

In the case of an urban aircraft, these configurations are often subject to mechanical stresses and/or oil and fuel coking.

To guard against this while guaranteeing a quick availability of the aircraft, the turbogenerator 1 includes a device 15 configured to stop at least the gas turbine 2.

More specifically, the device 15 is configured to control the electric machine 7 as well as the gas turbine 2.

Reference is made to FIG. 4 which illustrates a detailed view of the device 15.

As illustrated, the device 15 comprises control means 16, actuation means 17, comparison means 18, control means 19 as well as holding means 20.

The device 15 is herein configured to stop the gas turbine 2.

To do so, the control means 16 are configured to initiate the progressive stoppage of the gas turbine 2.

More particularly, the control means 16 are able to generate a setpoint signal to the actuation means 17 coupled to the gas turbine 2.

The actuation means 17 are configured to reduce the rated operating speed of the shaft 3 to a first operating speed lower than the rated speed.

As regards the comparison means 18, they are able to simultaneously verify whether the electrical energy level of the power supply means 8 is lower than a threshold value.

For example, this threshold value may be comprised between 0.15 kWh and 1.5 kWh.

To obtain information relating to the electrical energy level of the power supply means, the comparison means 18 are coupled to a management system 21.

More specifically, the management system 21 is coupled to the power supply means 8 and more particularly to the battery 9.

The comparison means 18 are further coupled to the electric machine 7 so as to make it operate in the generator mode.

In order to stop the combustion chamber 6, the control means 19 are coupled to the gas turbine 2 and are configured to control the operation of said chamber 6.

As regards the holding means 20, they are configured to make the electric machine 7 operate in the motor mode and thus keep the power shaft 3 rotating when the fuel is no longer injected into the combustion chamber 6.

Moreover, in order to implement a progressive stoppage of the rotation of the shaft 3, the device 15 further includes control means 22 configured to progressively stop the electric machine 7.

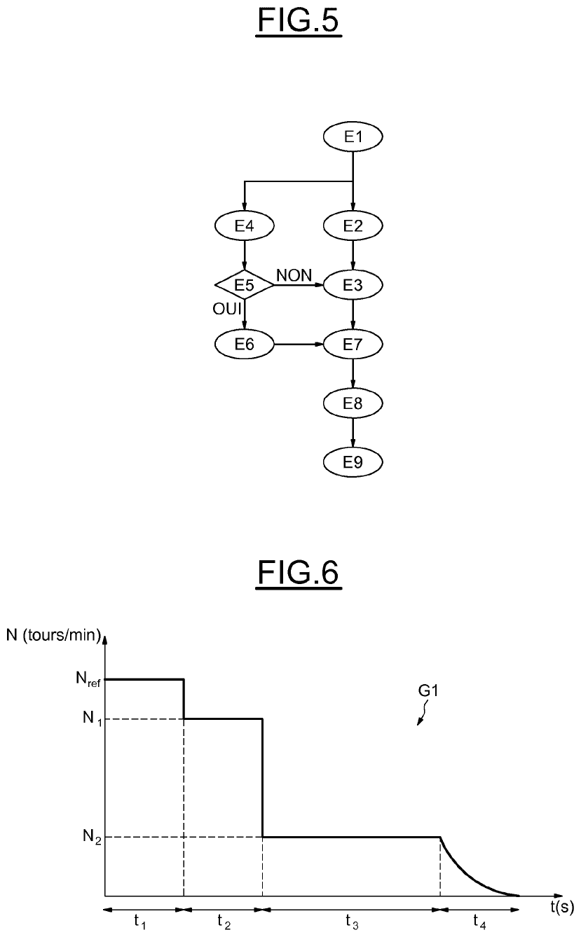

Reference is made to FIG. 5 which illustrates a flowchart of a method for stopping the power shaft 3 and/or 12, implemented by the device 15.

The method begins with a step E1 during which the control means 16 initiate the progressive stoppage of the power shaft 3 and/or 12 initially in a rated operating condition.

In step E2, the actuation means 17 control the gas turbine 2 so as to reduce the speed of the shaft 3 and/or 12 to the first operating speed.

Thus, in step E3, the gas turbine 2 operates at a speed lower than the rated operating speed for a predetermined duration.

For example, the first operating speed is comprised between 50 and 70% of the rated speed and the first predetermined duration is comprised between 30 and 120 seconds.

In other words, by continuing to inject a minimum amount of fuel into the combustion chamber 6, the gas turbine 2 operates at an operating speed close to the idle speed.

Thus, it is possible to cool the compartment of the gas turbine 2 while providing for the gas turbine to deliver a minimum of power to its power shaft 3 and/or 12.

Simultaneously, in step E4, the comparison means 18 verify the electrical energy level of the power supply means 8.

To do so, the management system 21 recovers the data relating to the state-of-charge of the power supply means 8 and particularly the battery 9.

During step E5, as soon as the comparison means 18 have said data, they compare them with the threshold value.

In other words, the comparison means verify whether the electric machine 7 is able to drive the shaft 3 and/or 12 for the second predetermined duration and that being so without injecting fuel into the combustion chamber 6.

To ensure this function, it is advantageous that the electrical energy level of the power supply means 8 is higher than the threshold value.

Thus, if the electrical energy level of the power supply means 8 is higher than the threshold value, the method switches to step E3 in which the first operating speed is kept for the predetermined duration. Then, the method switches to step E7 at the end of this step.

Conversely, when the electrical energy level of the power supply means 8 is lower than the threshold value, the electric machine 7 operates, in step E6, in the generator mode during the first predetermined duration in order to increase the electrical energy level of the power supply means 8.

During step E7, the control means 19 stop the combustion chamber 6.

In step E8, the holding means 20 control the electric machine in the motor mode to keep the shaft 3 and/or 12 rotating for the second predetermined duration comprised for example between 60 and 300 seconds.

Thus, the shaft 3 and/or 12 is in a second operating speed comprised for example between 5 and 15% of the rated operating speed, which improves cooling thereof.

Finally, in step E9, the control means 22 progressively stop the electric machine 7.

The rotational speed of the shaft 3 and/or 12 then decreases quickly until it reaches a zero speed.

This implementation allows obtaining an evolution over time, in seconds, of the operating speed N of the engine, in revolutions per minute, represented by a graph G1 illustrated in FIG. 6.

During a first phase t₁, the aircraft is in a cruise phase during which the shaft 3 and/or 12 of the gas turbine 2 is initially in a rated operating speed N_{ref}.

When the pilot begins the descent of the aircraft at the end of the phase t₁, he requests the progressive stoppage of the gas turbine 2.

Following this, the operating speed of the shaft 3 and/or 12 decreases rapidly to reach an operating speed N₁ close to the idle speed.

This allows having a first cooling level of the turbogenerator 1 by injecting little fuel into the combustion chamber 6.

In other words, the passage of the air flow while delivering a minimum of power at the output of the gas turbine 2 creates favourable conditions to start cooling the turbomachine in flight.

The first operating speed N₁ is herein comprised between 50 and 70% of the speed N_{ref} and is kept for the predetermined duration t₂ comprised between 30 and 120 seconds.

Afterwards, the combustion chamber 6 of the gas turbine 2 is extinguished to start a third phase t₃ comprised between 60 and 300 seconds, during which the electric machine 7 is controlled in a motor mode which allows driving the shaft 3 and/or 12 at a second speed N₂ in order to cool it by mixing air.

To optimise cooling of the gas turbine 2, the second speed N₂ is for example comprised between 5 and 15% of the rated speed N_{ref}.

Finally, in a last phase t₄, the electric machine 7 is stopped and therefore no longer drives the shaft 3 and/or 12. The rotational speed of the shaft 3 and/or 12 then decreases very quickly until it reaches a zero speed.

1. A method for stopping at least one turbogenerator for an aircraft, the turbogenerator comprising a reversible electric machine coupled to a gas turbine throughout at least one power shaft initially in a rated operating speed (N_{ref}), the method comprising:
controlling (E1) a stoppage of the turbogenerator;
switching from the rated operating speed (N_{ref}) of the power shaft to a first operating speed (N₁) lower than the rated operating speed (N_{ref}), for a first predetermined duration (t₂);
controlling (E7) an extinction of a combustion chamber of the gas turbine;
keeping (E8) the gas turbine rotating at a second operating speed (N₂) by driving it by the reversible electric machine electrically powered and operating in a motor mode for a second predetermined duration (t₃), the power shaft being in the second operating speed (N₂) lower than the first operating speed (N₁), and
controlling the stoppage of the reversible electric machine to no longer drive the power shaft and cause a progressive stoppage (E9, E10) of the rotation of the gas turbine.

2. The method according to claim 1, wherein the electric machine is coupled to electric power supply means, the method comprising verifying (E4, E5), following the stoppage control (E1), an electrical energy level of the power supply means, and if the electrical energy level is lower than a threshold value, an electrical generation control (E6) enabling the control of the gas turbine at a required mechanical power level and the control of the electric machine in a generator mode for the generation (E6) of an electric power for the first duration (t₂), able to be stored in the power supply means so as to reach the threshold value.

3. The method according to claim 1, wherein the first duration (t₂) is comprised between 30 and 120 seconds, and during which the first operating speed (N₁) is comprised between 50 and 70% of the rated operating speed (N_{ref}) of the power shaft of the gas turbine.

4. The method according to claim 1, wherein the second duration (t₃) is comprised between 60 and 300 seconds, and wherein the second operating speed (N₂) is comprised between 5 and 15% of the rated operating speed (N_{ref}) of a gas turbine engine.

5. A device for stopping at least one turbogenerator for an aircraft, the turbogenerator including a reversible electric machine coupled to a gas turbine throughout a shaft power initially in a rated operating speed (N_{ref}), the method comprising:
control means able to generate a stoppage setpoint signal (S1) of the turbogenerator;
actuation means able to switch, for a first predetermined duration (t₂), the rated operating speed (N_{ref}) of the power shaft to a first operating speed (N₁) lower than the rated operating speed (N_{ref});
control means for extinguishing a combustion chamber of the gas turbine);
means for keeping the gas turbine rotating at a second operating speed (N₂) by driving it by the reversible electric machine electrically powered and operating in a motor mode for a second predetermined duration (t₃), the power shaft being in the second speed (N₂) lower than the first operating speed (N₁), and
control means configured to stop the drive of the power shaft by the reversible electric machine and thus enable a progressive stoppage (t₄) of the rotation of the turbogenerator.

6. The device according to claim 5, wherein the electric machine is coupled to electric power supply means, the device comprising comparison means configured to verify, following the generation of the stoppage setpoint signal, an electrical energy level of the power supply means, and if the electrical energy level is lower than a threshold value, the electric machine is able to generate, for the first duration (t₂), an electric power able to be stored in the power supply means so as to reach the threshold value.

7. The device according to claim 5, wherein the first duration (t₂) is comprised between 30 and 120 seconds, and during which the first operating speed (N₁) is comprised between 50 and 70% of the rated operating speed (N_{ref}) of the power shaft of the gas turbine.

8. The device according to claim wherein the second duration (t₃) is comprised between 60 and 300 seconds, and during which the second operating speed (N₂) is comprised between 5 and 15% of the rated operating speed (N_{ref}) of the power shaft of the gas turbine.

9. The device according to claim 6, wherein the electric power supply means comprise at least one battery able to power the electric machine.

10. An aircraft comprising at least one turbogenerator including at least one gas turbine, a reversible electric machine and at least one stopping device according to claim 5.
